(19) United States
(12) Patent Application Publication
(10) Pub. No.: US 2022/0180201 A1
(43) Pub. Date: Jun. 9, 2022

(54) MOLECULE EMBEDDING USING GRAPH NEURAL NETWORKS AND MULTI-TASK TRAINING

(71) Applicant: Microsoft Technology Licensing, LLC, Redmond, WA (US)

(72) Inventors: Mohammad Reza SARSHOGH, Seattle, WA (US); Robin ABRAHAM, Redmond, WA (US)

(21) Appl. No.: 17/208,110

(22) Filed: Mar. 22, 2021

Related U.S. Application Data
(60) Provisional application No. 63/122,356, filed on Dec. 7, 2020.

(51) Int. Cl. G06N 3/08; G06N 3/04

(52) U.S. Cl. CPC G06N 3/084; G06N 3/04

(57) ABSTRACT

An embedding model maps a graph representation of a molecule to an embedding space. The embedding model may include one or more graph neural network layers that use a message passing framework and one or more attention layers. The one or more attention layers may determine an edge weight for each message received by a receiving node from one or more sending nodes. The edge weight may be based on features of the receiving node and features of the one or more sending nodes. The one or more graph neural network layers may determine embedded features for the graph based on the messages and the edge weights. The embedding model may determine molecule features for the molecule based on the embedded features. The molecule features may map to an embedding space. The embedding model may be trained using multi-task training to generate a more generic embedding space.

### CROSS-REFERENCE TO RELATED APPLICATIONS

This application is related to and claims the benefit of U.S. Provisional Patent Application No. 63/122,356 filed on Dec. 7, 2020. The aforementioned application is expressly incorporated herein by reference in its entirety.

### BACKGROUND

Measuring molecule properties and detecting similar molecules play a major role in drug discovery and development. Properties of a first molecule may be known. It may be desirable to identify other molecules that have properties similar to the properties of the first molecule. But using a lab to identify molecules similar to known molecules based on some specific criteria is very expensive and time consuming. And selecting which properties to measure may also be time consuming and expensive. Depending on the instrument and measurement procedure, there may be inconsistencies in measured data, which may affect the usability of the measured data. Furthermore, because of budgetary and time limitations, it may not be possible to measure selected properties on all eligible molecules.

### SUMMARY

In accordance with one aspect of the present disclosure, a method is disclosed that includes receiving, at a graph neural network, an edge weight for a message sent from a second node of a graph to a first node of the graph. An edge connects the second node to the first node, the first node includes first features, the second node includes second features, the edge includes edge features, the message includes the edge features, and the edge weight is based on the first features and the second features. The method also includes determining, at the graph neural network, embedded features of the first node. The embedded features of the first node are based on the message and the edge weight.

The graph may represent a molecule.

The graph may be based on a simplified molecular-input line-entry system (SMILES) of the molecule.

The graph neural network may be a graph isomorphism network (GIN).

The method may further include receiving, at the graph neural network, a second edge weight for a second message sent from a third node of the graph to the first node of the graph. A second edge may connect the third node to the first node. The third node may include third features, the second edge may include second edge features, the second message may include the second edge features, and the second edge weight may be based on the first features and the third features.

The method may further include determining, at the graph neural network, the embedded features of the first node is further based on the second message and the second edge weight.

The message may include the second features.

The edge weight may be further based on a learned weighting coefficient.

In accordance with another aspect of the present disclosure, a method is disclosed that includes receiving a graph. The graph includes nodes and edges. Each of the nodes includes node features, and each of the edges comprises edge features. The method further includes determining, using two or more graph neural network layers, two or more embedded features for the nodes. Embedded features for a node are based on messages received by the node from one or more neighboring nodes and edge weights associated with the messages. Each message includes edge features of an edge connecting a neighboring node to the node and node features of the neighboring node. Each edge weight is based on the node features of the neighboring node and node features of the node. The method further includes determining graph features for the graph based on the two or more embedded features.

The graph may represent a molecule.

The graph may be based on a simplified molecular-input line-entry system (SMILES) of the molecule.

The method may further include receiving, at a property predictor, the graph features for the graph. The method may further include predicting, using the property predictor, a characteristic of the molecule based on the graph features.

The method may further include mapping the graph features to an embedding space and identifying one or more graphs within a threshold distance of the graph in the embedding space.

The two or more graph neural network layers may include a graph isomorphism network (GIN) layer.

The two or more graph neural network layers may receive the edge weights from two or more attention layers and the edge weights may be used to identify a portion of the molecule that played a more important role during inference than another portion of the molecule.

In accordance with another aspect of the present disclosure, a method is disclosed that includes receiving, at an embedding model, examples from a training data batch. The examples from the training data batch are associated with three or more tasks. Each example from the training data batch includes a graph that represents a molecule. The method further includes outputting, from the embedding model, molecule features for each example received from the training data batch. The molecule features map to an embedding space. The method further includes receiving, at the embedding model, for each example in the training data batch, back propagation from a loss function associated with at least one of the three or more tasks. The method further includes modifying learnable weights of the embedding model based on the back propagation.

The embedding model may include one or more graph neural network layers and one or more attention layers.

The graph may include nodes and edges. The one or more graph neural network layers may use a message-passing framework. The one or more attention layers may determine edge weights to be applied to messages received by a receiving node in the graph from one or more sending nodes in the graph. The molecule features may be based in part on the edge weights and the messages.

The edge weights may be based on features of the receiving node and the one or more sending nodes.

The edge weights may be further based on a weighting coefficient and the one or more attention layers may modify the weighting coefficient based on the back propagation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example system for predicting a characteristic of a molecule.

FIG. 2 illustrates an example graph that includes nodes and edges.

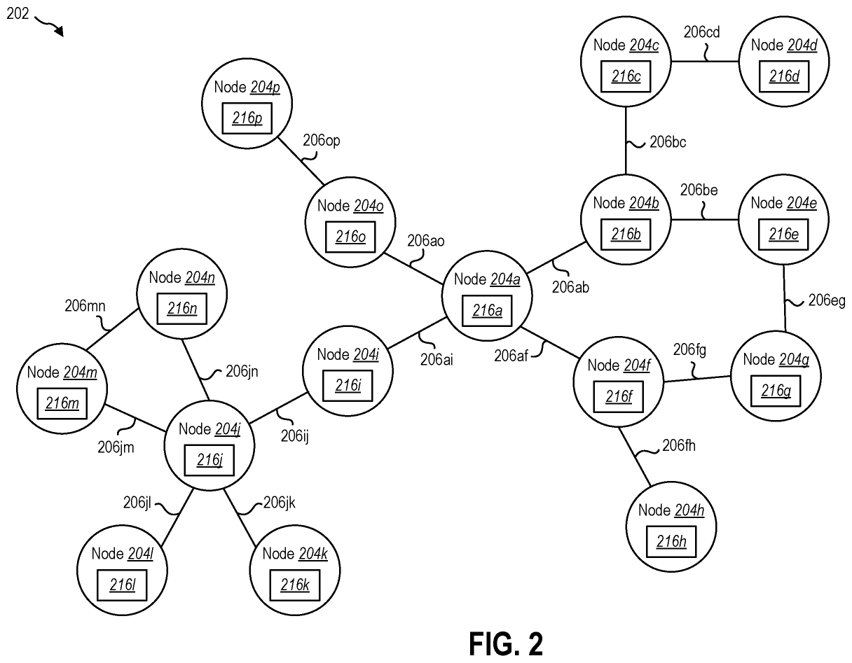

FIG. 3A illustrates an example node embedding model that includes graph neural network layers and attention layers.

FIG. 3B illustrates neighboring nodes passing messages to a receiving node.

FIG. 4 illustrates an example node aggregation model.

FIG. 5 illustrates using multi-task training in connection with an embedding model.

FIG. 6 illustrates an example method for determining embedded features of a node in a graph.

FIG. 7 illustrates an example method for determining graph features for a graph.

FIG. 8 illustrates an example method for training an embedding model using training data associated with multiple different tasks.

FIG. 9 illustrates certain components that can be included within a computing device.

### DETAILED DESCRIPTION

Measuring molecule properties and detecting similar molecules may be important to drug discovery and development. Certain properties of a first molecule may be known. It may be desirable to identify other molecules that have properties similar to the certain properties of the first molecule. For example, a first molecule may be known to be effective for treating HIV, and it may be desirable to identify other molecules that have properties similar to the first molecule because such other molecules may also be effective for treating HIV. But identifying other molecules that have properties similar to the certain properties of the first molecule may be challenging. Identifying similar molecules may involve expensive and time-consuming laboratory work. And selecting which properties of eligible molecules to measure may also be time consuming and expensive. Depending on the instrument and measurement procedure, there may be inconsistencies in measured data, which may affect the usability of the measured data. Furthermore, because of budgetary and time limitations, it may not be possible to measure selected properties on all the eligible molecules.

This disclosure concerns systems and methods for efficiently identifying molecules that may have similar properties. The systems and methods may use an embedding model to map a graph representation of a molecule to an embedding space based on a molecular structure of the molecule. The embedding model may learn to do the mapping using multi-task training. Mapping the molecule to the embedding space may allow efficient comparison of the molecule with another molecule (which may have certain known properties) that has been mapped to the embedding space. Mapping the molecule to the embedding space may also allow efficient predictions regarding whether the molecule will be effective for a particular task or will possess a particular property.

One way the embedding model may facilitate finding molecules with similar properties is through mapping molecules to the embedding space. Once the molecules are mapped to the embedding space, it may be possible to determine distances between the molecules in the embedding space. It may be that when a first molecule is close to a second molecule in the embedding space (which may be referred to as neighboring molecules), the first molecule and the second molecule may have similar properties. Thus, if the first molecule has known properties, lab testing may focus on molecules that neighbor the first molecule to determine whether those neighboring molecules also have the known properties. Using this approach may reduce the search space considerably and consequently reduce the required time and expenses.

Another way the embedding model may facilitate identifying molecules with certain properties is through merging the embedding model with another model (such as a task-specific model) to predict different properties of a molecule (such as predicting whether a given molecule has antibiotic properties). This use of the embedding model may be similar to how pretrained ResNet and DenseNet models are used in connection with computer vision models. Once a molecule is mapped to an embedding space, a representation of the molecule in the embedding space may be input into a task-specific machine learning model. The task-specific machine learning model may be trained to predict whether the molecule has a specific characteristic or property based on the representation of the molecule in the embedding space. For example, the task-specific machine learning model may predict whether the molecule has antibiotic properties.

The graph representation of the molecule (which may be referred to as a molecule graph) may include a node (which may be referred to as a vertex) for each atom in the molecule and an edge (which may be referred to as a link) for each bond connecting atoms in the molecule. Each node in the graph and each edge in the graph may have features. The features may convey information regarding the node or the edge. Features of each node in the graph may be based on attributes and characteristics of each corresponding atom, such as atomic number, chirality, charge, etc. Features of each edge in the graph may be based on attributes and characteristics of each corresponding bond, such as bond type, bond direction, etc. The graph representation of the molecule may be based on a simplified molecular-input line-entry system (SMILES). A SMILES may be a specification in the form of a line notation for describing the structure of chemical species using short ASCII strings. SMILES strings may be imported by most molecule editors for conversion back into two-dimensional drawings or three-dimensional models of the molecules. RDKit library may translate SMILES to molecule structure. The molecule structure generated by RDKit may be converted to a graph data structure that may be consumed by the embedding model as an input. RDKit may be a collection of cheminformatics and machine-learning software written in C++ and Python. RDKit may include descriptor generation for machine learning.

The embedding model may include a node to vector model (an atom embedding model), which may use graph neural networks to map each atom of a molecule to a feature space based on a molecule structure of the molecule. The embedding model may include an aggregation model that generates molecule features based on learned features of atoms in the molecule. The node to vector model may, using graph neural networks, generate embedded atom features (learned features) for each atom in the molecule (which may be represented by a graph based on a structure of the molecule). The aggregation model may generate embedded molecule features (learned features) for the molecule based on the learned features of the atoms. The learned features for the molecule may define a location of the molecule in an embedding space.

The atom embedding model may include an embedding layer and one or more graph neural network (GNN) layers. A GNN may be a type of neural network that operates directly on a graph structure. A GNN may follow a recursive neighborhood aggregation scheme.

The embedding layer may map an atomic number of each atom (which may be represented as a node in an input graph) to a denser feature space, which may help the embedding model learn a more accurate feature space for atoms. The embedding layer may map an atomic number of each node to a vector of a defined size using linear mapping and/or a lookup table. The embedding layer may learn to map an atomic number to a feature space based on back propagation. The embedding layer may be a standard way of moving from a discrete set of entities (such as atoms) to a more dense space (such as a vector of size n). The vector associated with each atomic number plus other features of the atom may define updated features of the node. The atomic number and the other features of the atom may be input features of the node that represent the atom. The updated features of the node may be based on the input features of the node. The updated features of the node may be a singular representation that has all the information of the input features of the node embedded into it. The input features of the node may be based on attributes and characteristics of the node.

Each GNN layer in the one or more GNN layers may receive a molecule graph and determine embedded atom features for each atom in the molecule graph. The embedded atom features of an atom may convey specific information regarding the atom, its associated bonds, and a neighborhood of the atom. A first GNN layer in the one or more GNN layers may receive the input graph or the updated graph and determine first layer embedded atom features for each atom in the molecule. Each subsequent GNN layer may receive an output graph from a previous GNN layer and determine next layer embedded atom features for each atom based on the output graph. The one or more GNN layers may be Graph Isomorphism Network (GIN) layers.

The one or more GNN layers included in the embedding model may use a message-passing framework. At each of the one or more GNN layers, each node in a graph (which may be a molecule graph) may receive a message from each neighboring node. Two nodes may be neighboring nodes if the two nodes are connected by an edge in the graph. A message may be based on node features of a sending node and edge features of an edge connecting the sending node to a receiving node. For example, the one or more GNN layers may construct the message by concatenating the node features of the sending node with the edge features of the edge connecting the sending node to the receiving node.

The one or more GNN layers may use an attention mechanism to prioritize (i.e., weight) messages from neighboring nodes. An attention layer may determine a weight (which may be referred to as an edge weight) to apply to each message. The edge weight for each message may be based on node features of a node sending the message (a sending node) and node features of a node receiving the message (a receiving node). The one or more GNN layers may learn to determine the edge weight for each message based on a correlation between the node features of the sending node and the node features of the receiving node. For example, the one or more GNN layers may determine the edge weight by concatenating the node features of the sending node and the node features of the receiving node, applying a linear layer, and applying a sigmoid activation to the output. By using an attention mechanism, the embedding model may learn how to prioritize different messages sent to a receiving node based on a relationship between features of a sending node and features of the receiving node. Using the attention mechanism and edge weights that are based on features of a sending node and features of a receiving node may improve accuracy of the embedding model when used in connection with performing downstream tasks.

The following expression illustrates one example of how the one or more GNN layers may determine features xᵢ′ for a node i in a graph:

$${x}_{i}^{′} = {h}_{Θ} ( {x}_{i} + {\sum }_{j ∈ N ( i )}^{ } ( {x}_{j} + {e}_{j , i} ) \times {ew}_{j , i} )$$

where xᵢ′ is an output of a GNN layer for node i, (xⱼ+e_{j,i}) (which may be referred to as m_{j,i}) is the message from node j to node i, xⱼ is the features of node j, e_{j,i} is the features of the edge connecting node j to node i, ew_{j,i} is the edge weight for the message from node j to node i, and h_{θ} denotes a neural network.

The following expression illustrates one example of how ew_{j,i} may be determined:

ew_{j,i}=σ((xⱼ+xᵢ)×W_{f}+b_{f})

where ew_{j,i} is the edge weight and the attention mechanism, xⱼ is the features of the sending node, xᵢ is the features of the receiving node, W_{f} is a learned weighting coefficient, b_{f} is a learned bias coefficient, and σ is a non-linearity. W_{f} may be learned based on features of two ends of the edge.

As noted above, each of the one or more GNN layers may output embedded atom features for each atom in a molecule graph. The outputted embedded atom features may be referred to as a hidden state for the atom. An attention layer may use the hidden states (or, in a case of an attention layer associated with a first GNN layer, atom features of an input graph or updated graph) to generate edge weights for a GNN layer (which may be referred to as a next GNN layer) subsequent to a GNN layer (which may be referred to as a previous GNN layer) that generated the hidden states. The next GNN layer may receive the hidden states from the previous GNN layer as atom features and may receive the edge weights from the attention layer. The next GNN layer may output new hidden states based on the hidden states and the edge weights. The atom embedding model may include multiple attention layers and GNN layers stacked on top of each other. Each additional layer may provide visibility to further neighbors from any given node.

After generating embedded atom features using a stack of GNN layers, the atom aggregation model may generate a molecule embedding (which may also be referred to as molecule features). The atom aggregation model may generate the molecule embedding based on the embedded atom features. The atom aggregation model may first aggregate embedded atom features generated by each of the one or more GNN layers to generate aggregated atom features for each atom in the molecule graph. The atom aggregation model may then aggregate the aggregated atom features to generate the molecule features. One aggregation strategy may be based on concatenating the embedded atom features generated by each of the one or more GNN layers to generated aggregated atom features and then using an attention pooling layer to prioritize aggregated atom features of different atoms. The attention pooling layer may learn how to prioritize aggregated atom features of different atoms to calculate molecule features such that the embedding model achieves a highest accuracy in all downstream tasks.

Multi-task training may be used to train the embedding model. Multi-task training may result in the embedding model being sufficiently generic such that the embedding model may be used as a core in different regression, classification, or clustering models. Training the embedding model on only a single downstream task (such as predicting a single property of a molecule) may result in an embedding space that specifically captures features required to predict the single downstream task with a highest accuracy. As a result, the learned features and embedding space may not necessarily be useful for some other task. To avoid this result the embedding model may be trained on a wide range of tasks at the same time (which may be referred to as multi-task training). By training the embedding model on a wide range of tasks (such as predicting a variety of molecule properties, especially properties that are not correlated), the embedding model may generate more generic molecule features and a more generic embedding space that captures a wide range of important features. Therefore, there is a higher chance that the molecule embedding contains the required information to be used in a variety of tasks. For example, a generic embedding model trained using multi-task training may be used as a core of other models to improve accuracy and training time for the other models. A generic embedding model trained using multi-task training may also be helpful when the embedding model has access to only limited training data for a specific task. The embedding space itself may also be used to find similar molecules or find molecule clusters that share interesting properties (such as solubility).

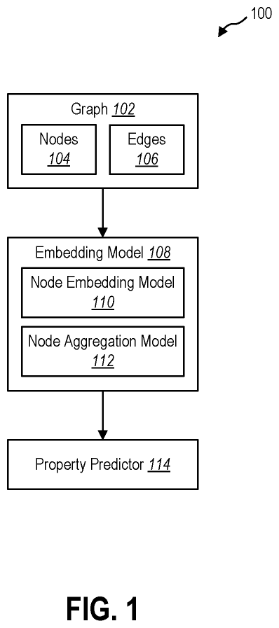

FIG. 1 illustrates a system 100. The system 100 may include a graph 102, an embedding model 108, and a property predictor 114.

The graph 102 may be a data structure. The graph 102 may contain information regarding real-world entities and relationships between the real-world entities. As one example, the graph 102 may represent a molecule and contain information regarding atoms that form the molecule and regarding bonds between and among the atoms of the molecule. In the case of a molecule, the graph 102 may be based in part on a SMILES of the molecule. As another example, the graph 102 may represent a social network, a biological system, or a financial system.

The graph 102 may include nodes 104 (which may also be referred to as vertices) and edges 106 (which may also be referred to as links).

The nodes 104 may represent component entities that make up the graph 102. The nodes 104 may have features. The features may contain information regarding properties of the nodes 104. For example, consider that the graph 102 represents a molecule and the nodes 104 represent atoms within the molecule. The atoms within the molecule may have certain properties such as atomic numbers and chirality. The features of the nodes 104 may include the properties of the atoms. The features of the nodes 104 may be based on the properties of the atoms. For example, the features of the nodes 104 may be determined using one-hot encoding and/or linear mapping based on the properties of the atoms. The features of the nodes 104 may be represented in a vector.

The edges 106 may represent relationships between pairs of nodes. The edges 106 may be directional or non-directional. The edges 106 may have features that contain information regarding the relationships between the pairs of nodes. For example, in the situation in which the graph 102 represents a molecule, the edges 106 may represent bonds between atoms within the molecule. The bonds between the atoms within the molecule may have certain properties, such as bond type and bond direction. The features of the edges 106 may include the properties of the bonds. The features of the edges 106 may be based on the properties of the edges 106. For example, the features of the edges 106 may be generated based on the properties of the bonds. The features of the edges 106 may be represented in a vector.

The embedding model 108 may include a machine learning model that receives a graph (such as the graph 102) and outputs a representation of the graph in an embedding space. The embedding space may be a Euclidean space. The embedding space may be any space in which a point in the embedding space can be defined using numbers. The embedding space may have a defined number of dimensions. Each point in the embedding space may be defined by certain values for each dimension. The representation of the graph in the embedding space may be a vector having a same number of dimensions as the embedding space. The embedding space may be denser than a space in which the graph exists. For example, the graph may represent a molecule. The molecule may exist in a space of all molecules. The embedding model 108 may output a representation of the molecule in an embedding space. The representation of the molecule in the embedding space may be molecule features of the molecule. The embedding space may be denser than the space of all molecules.

The embedding model 108 may include a node embedding model 110 and a node aggregation model 112.

The node embedding model 110 may include one or more GNN layers. Each of the one or more GNN layers may receive an input graph and output an embedded graph (which may be a hidden state). At each of the one or more GNN layers, each node in the input graph may have a corresponding node in the embedded graph. Each node in the input graph may have input features. Each corresponding node in the embedded graph may have embedded features. Embedded features of an output node in an embedded graph (which may correspond to an input node in an input graph) may contain more information about the output node than is contained in input features of the input node. Each of the one or more GNN layers may learn to take the input features (which may have no correlation or an unknown correlation) and neighborhood information and map the input features and the neighborhood information to a singular representation (embedded features) that has all that information embedded into it. The one or more GNN layers may learn to determine the embedded features to achieve a highest accuracy on all downstream tasks. Each of the one or more GNN layers may access structure information contained in the input graph in determining the embedding features.

At least one of the one or more GNN layers may use a message-passing framework and an attention mechanism to determine, based on an input graph, embedded features for an embedded graph. Each node in the input graph may receive a message from each neighboring node in the input graph. A neighboring node of a node may be any node connected to the node by an edge. A message from a neighboring node to a receiving node may be based on features of the neighboring node and features of an edge connecting the neighboring node to the receiving node. A GNN layer may use messages received by a receiving node from neighboring nodes to determine embedded features of the receiving node.

A GNN layer may use the attention mechanism to weight each of the messages received by the receiving node in determining the embedded features. The GNN layer may receive weights for each of the messages from an attention layer. The attention layer may, for each message, determine a weight based on features of a node in the input graph that is sending the message and features of a node in the input graph that is receiving the message. The weights may communicate to the GNN layer which neighboring node's information is most important. The attention layer may learn how to put weights on the messages. The attention layer may learn how to put weights on the messages based on a correlation of features of a receiving node and features of a sending node. Utilizing weights determined based on features of a receiving node and features of a sending node in order to determine embedded features may increase an accuracy of the embedding model 108 in connection with performing downstream tasks. These weights may also be used to investigate and identify portions of a molecule structure that were more important during the inference.

The node aggregation model 112 may determine molecule features for an input graph (such as the graph 102) based on embedded graphs generated by the one or more GNN layers. The molecule features may define a location in an embedding space of the input graph. The node aggregation model 112 may determine aggregated node features for each node in the input graph. The aggregated node features for a node may be based on embedded features of the node in the embedded graphs. For example, the node aggregation model 112 may determine the aggregated node features by determining an average of the embedded features of the node in the embedded graphs.

The node aggregation model 112 may determine the molecule features based on the aggregated node features of the nodes. The node aggregation model 112 may prioritize aggregated node features of some nodes of the input graph over other nodes of the input graph. The node aggregation model 112 may determine a weight to apply to aggregated node features of each node in the input graph in determining the molecule features. The node aggregation model 112 may learn to determine weights to apply to aggregated node features to achieve a highest accuracy on downstream tasks.

The property predictor 114 may receive an output of the embedding model 108. The output of the embedding model 108 may be the molecule features. The property predictor 114 may use the output of the embedding model 108 to perform a specific downstream task. An example downstream task may be predicting whether a molecule represented by an input graph (such as the graph 102) has a particular property (such as predicting octanol/water distribution coefficient of molecules). The property predictor 114 may include a machine learning model that learns how to perform the specific downstream task based on the output of the embedding model 108.

The output of the embedding model 108 may be used to map the input graph to a point in the embedding space. The embedding space may allow for determining a distance between the input graph and other molecules mapped to the embedding space. Molecules that are within a threshold distance in the embedding space may have similar properties.

FIG. 202 illustrates an example graph 202. The graph 202 may represent a molecule. The graph 202 may be an input to an embedding model (such as the embedding model 108), an input to an embedding layer, an output of an embedding layer, a hidden state within an embedding model, or an output of a node embedding model (such as the node embedding model 110).

The graph 202 may include nodes 204a-p. In other designs, the graph 202 may include fewer or more nodes. Each of the nodes 204a-p may represent an atom in a molecule. The nodes 204a-p may include features 216a-p. The features 216a-p may be based on properties of atoms represented by the nodes 204a-p. For example, the node 204a may represent a first atom in a molecule. The first atom may have an atomic number, a chirality, and a charge. The features 216a may be based on the atomic number, the chirality, and the charge of the first atom. The features 216a-p may be represented in vectors. The features 216a-p may be embedded features.

The graph 202 may include edges 206ab, 206bc, 206be, 206cd, 206eg, 206af, 206fg, 206fh, 206ai, 206ij, 206jk, 206jl, 206jm, 206jn, 206mn, 206ao, 206op (which may be referred to as edges 206ab-op). The edges 206ab-op may represent bonds in the molecule. Each of the edges 206ab-op may include edge features. The edge features may be based on properties of the bonds represented by the edges 206ab-op. For example, the edge 206ab may represent a first bond in a molecule. The first bond may have a bond type and a bond direction. Edge features of the edge 206ab may be based on the bond type and the bond direction. The edge features may be represented in vectors.

In situations in which the graph 202 is a hidden state within an embedding model, the features 216a-p may be based on more than properties of the atoms that the nodes 204a-p represent. Consider an example in which the graph 202 is a hidden state (an output) of a first graph neural network layer in an embedding model. Assume that the first graph neural network layer receives an input graph. The features 216a of the node 204a may be based not only on properties of an atom that the node 204a represents but may also be based on features of neighboring nodes (which, if temporarily viewing the graph 202 as the input graph, would be the features 216b of the node 204b, the features 216f of the node 204f, the features 216i of the node 204i, and the features 216o of the node 204o). The features 216a of the node 204a may further be based on edge properties of edges that connect the node 204a to its neighboring nodes (which, if temporarily viewing the graph 202 as the input graph, would be the edge 206ab, the edge 206af, the edge 206ai, and the edge 206ao). In a situation in which the first graph neural network layer utilizes an attention mechanism, the features 216a may be based on edge weights. The edge weights may be based on features of the neighboring nodes of the node 204a in the input graph and the features 216a in the input graph.

Consider another example in which the graph 202 is a hidden state (an output) of a second graph neural network layer that is subsequent to the first graph neural network layer of the example above. In such an example, the features 216a of the node 204a may be further based not only on features of neighboring nodes of the node 204a but also on features of nodes that neighbor the neighboring nodes of the node 204a (which, if temporarily viewing the graph 202 as an output from the first graph neural network layer, would be the features 216c of the node 204c, the features 216e of the node 204e, the features 216g of the node 204g, the features 216h of the node 204h, the features 216j of the node 204j, and the features 216p of the node 204p). The features 216a of the node 204a may further be based on edge features (which, if temporarily viewing the graph 202 as the output from the first graph neural network layer, would be the edge 206bc, the edge 206be, the edge 206fg, the edge 206fh, the edge 206ij, and the edge 206op). In a situation in which the second graph neural network layer utilizes an attention mechanism, the features 216a may be based on edge weights. The edge weights may be based on features of the neighboring nodes of the node 204a in the output from the first graph neural network layer and the features 216a in the output from the first graph neural network layer.

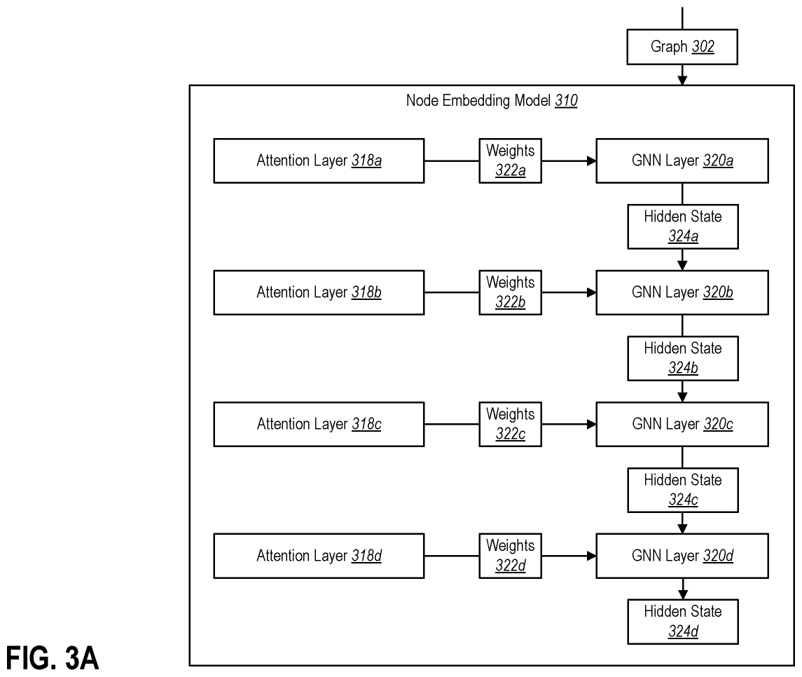

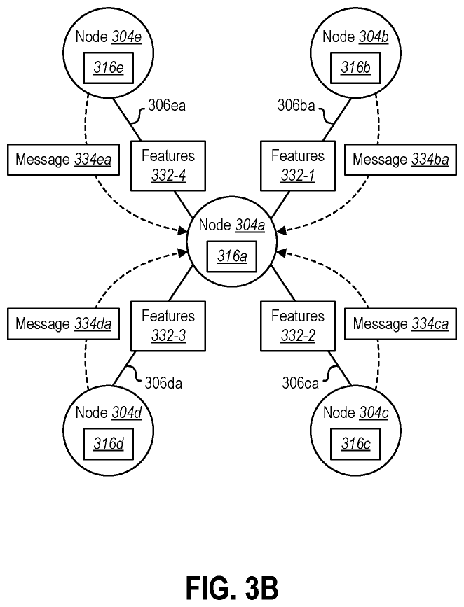

FIG. 3A may illustrate a node embedding model 310. The node embedding model 310 may receive a graph 302. The graph 302 may represent a molecule. The graph 302 may be the graph 102 or the graph 202.

The node embedding model 310 may include attention layers 318a-d and GNN layers 320a-d. The GNN layers 320a-d may determine hidden states 324a-d, and the attention layers 318a-d may determine weights 322a-d. Although the node embedding model 310 includes four GNN layers, in other designs, a node embedding model may include fewer GNN layers (such as a single GNN layer) or more GNN layers. Although the node embedding model 310 includes an attention layer for each GNN layer, in other designs, one or more GNN layers may not have an associated attention layer. For example, a node embedding model may include a first GNN layer and a second GNN layer. The first GNN layer may not have an associated attention layer while the second GNN layer may have an associated attention layer.

The GNN layer 320a may receive an input graph. The input graph may be the graph 302 or a modified version of the graph 302. For example, the node embedding model 310 may use a mapping layer to map atomic numbers to a dense feature space and replace the atomic number in each node with generated features. Each node in the input graph may receive a message from each neighboring node. A node that receives a message may be referred to as a receiving node and a node that sends the message may be referred to as a sending node. The message may include features of the sending node and features of an edge connecting the sending node and the receiving node. The features of the edge connecting the sending node and the receiving node may be different from features of an edge connecting the receiving node to the sending node. In other words, edges of the input graph may be directional.

The attention layer 318a may receive the graph 302 or a modified version of the graph (or a subset of the foregoing). The attention layer 318a may output the weights 322a to the GNN layer 320a. The weights 322a may include a weight for each message sent by a sending node to a receiving node. The attention layer 318a may determine the weights 322a based on features of the sending node and features of the receiving node. For example, the attention layer 318a may determine the weights 322a based in part on concatenating the features of the sending node and the features of the receiving node. The attention layer 318a may learn how to determine the weights 322a based on a relationship between features of a sending node and features of a receiving node. For example, the attention layer 318a may learn a weighting coefficient and a bias coefficient for determining the weights 322a. The attention layer 318a may apply the weighting coefficient to a concatenation of the features of the sending node and the features of the receiving node. The attention layer 318a may concatenate the bias coefficient to a result of the foregoing calculation. The attention layer 318a may then apply a sigmoid.

The GNN layer 320a may determine the hidden state 324a for the input graph. The hidden state 324a may be a graph identical to the input graph except that nodes of the hidden state 324a may have features different from input features of nodes in the input graph. The features of a node of the hidden state 324a may be referred to as embedded features of the node or a hidden state of the node. The GNN layer 320a may determine embedded features for each node in the hidden state 324a. The embedded features for each node in the hidden state 324a may be based on messages received by the node, weights associated with the messages received by the node (which may be contained in the weights 322a), and input features of the node in the input graph. The GNN layer 320a may learn how to determine the embedded features for each node in the hidden state 324a such that one or more downstream tasks may be predicted with a highest accuracy. Edges of the hidden state 324a may have edge features identical to edges of the input graph.

The GNN layer 320b may receive the hidden state 324a. Each node in the hidden state 324a may receive a message from each neighboring node. The message may include features of the sending node and features of an edge connecting the sending node and the receiving node. The features of the sending node may give the receiving node visibility to features of nodes that neighbor the sending node.

The attention layer 318b may receive the hidden state 324a or a subset of the hidden state 324a. The attention layer 318b may output the weights 322b to the GNN layer 320b. The weights 322b may include a weight for each message sent by a sending node to a receiving node. The attention layer 318b may determine the weights 322b based on features of the sending node and features of the receiving node. For example, the attention layer 318b may determine the weights 322b based in part on concatenating the features of the sending node and the features of the receiving node. The attention layer 318b may learn how to determine the weights 322b based on a relationship between features of a sending node and features of a receiving node. The attention layer 318b may learn how to determine the weights 322b in a same way as the attention layer 318a may learn to determine the weights 322a.

The GNN layer 320b may determine the hidden state 324b for the hidden state 324a. The hidden state 324b may be a graph identical to the hidden state 324a except that nodes of the hidden state 324b may have features different from features of nodes of the hidden state 324a. The features of a node of the hidden state 324b may be referred to as embedded features of the node or a hidden state of the node. The GNN layer 320b may determine the embedded features for each node in the hidden state 324b. The embedded features for each node in the hidden state 324b may be based on messages received by the node, weights associated with the messages received by the node (which may be contained in the weights 322b), and features of the node in the hidden state 324a. The GNN layer 320b may learn how to determine the embedded features for each node in the hidden state 324b such that one or more downstream tasks may be predicted with a highest accuracy. Edges of the hidden state 324b may have edge features identical to edges of the hidden state 324a.

The GNN layer 320c may receive the hidden state 324b. Each node in the hidden state 324b may receive a message from each neighboring node. The message may include features of the sending node and features of an edge connecting the sending node and the receiving node. The features of the sending node may give the receiving node visibility to features of nodes that neighbor neighbors of the sending node.

The attention layer 318c may receive the hidden state 324b or a subset of the hidden state 324b. The attention layer 318c may output the weights 322c to the GNN layer 320c. The weights 322c may include a weight for each message sent by a sending node to a receiving node. The attention layer 318c may determine the weights 322c based on features of the sending node and the receiving node. For example, the attention layer 318c may determine the weights 322c based on concatenating the features of the sending node and the features of the receiving node. The attention layer 318c may learn how to determine the weights 322c based on a relationship between features of a sending node and features of a receiving node. The attention layer 318c may learn how to determine the weights 322c in a same way as the attention layer 318a may learn to determine the weights 322a.

The GNN layer 320c may determine the hidden state 324c for the hidden state 324b. The hidden state 324c may be a graph identical to the hidden state 324b except that nodes of the hidden state 324c may have features different from features of nodes of the hidden state 324b. The features of a node of the hidden state 324c may be referred to as embedded features of the node or a hidden state of the node. The GNN layer 320c may determine the embedded features for each node in the hidden state 324c. The embedded features for each node in the hidden state 324c may be based on messages received by the node, weights associated with the messages received by the node (which may be contained in the weights 322c), and features of the node in the hidden state 324b. The GNN layer 320c may learn how to determine the embedded features for each node in the hidden state 324c such that one or more downstream tasks may be predicted with a highest accuracy. Edges of the hidden state 324c may have edge features identical to edges of the hidden state 324b.

The GNN layer 320d may receive the hidden state 324c. Each node in the hidden state 324c may receive a message from each neighboring node. The message may include features of the sending node and features of an edge connecting the sending node and the receiving node. The features of the sending node may give the receiving node visibility to features of nodes that neighbor neighbors of neighbors of the sending node.

The attention layer 318d may receive the hidden state 324c or a subset of the hidden state 324c. The attention layer 318d may output the weights 322d to the GNN layer 320d. The weights 322d may include a weight for each message sent by a sending node to a receiving node. The attention layer 318d may determine the weights 322d based on features of the sending node and features of the receiving node. For example, the attention layer 318d may determine the weights 322d based on concatenating the features of the sending node and the features of the receiving node. The attention layer 318d may learn how to determine the weights 322d based on a relationship between features of a sending node and features of a receiving node. The attention layer 318d may learn how to determine the weights 322d in a same way as the attention layer 318a may learn to determine the weights 322a.

The GNN layer 320d may determine a hidden state 324d for the hidden state 324c. The hidden state 324d may be a graph identical to the hidden state 324b except that nodes of the hidden state 324d may have features different from features of nodes of the hidden state 324c. The features of a node of the hidden state 324d may be referred to as embedded features of the node or a hidden state of the node. The GNN layer 320d may determine the embedded features for each node in the hidden state 324d. The embedded features for each node in the hidden state 324d may be based on messages received by the node, weights associated with the messages received by the node (which may be contained in the weights 322d), and features of the node in the hidden state 324c. The GNN layer 320d may learn how to determine the embedded features for each node in the hidden state 324d such that one or more downstream tasks may be predicted with a highest accuracy. Edges of the hidden state 324d may have edge features identical to edges of the hidden state 324c.

The embedded features for nodes included in the hidden states 324a-d may have a same size or different sizes.

FIG. 3B illustrates a receiving node and four sending nodes that may exist in the graph 302, a graph input into the GNN layer 320a, or the hidden states 324a-c.

A node 304a may include features 316a.

The node 304a may receive a message 334ba from node 304b. The node 304b may include features 316b. Edge 306ba may include features 332-1. The message 334ba may be based on the features 316b and the features 332-1.

The node 304a may receive a message 334ca from node 304c. The node 304c may include features 316c. Edge 306ca may include features 332-2. The message 334ca may be based on the features 316c and the features 332-2.

The node 304a may receive a message 334da from node 304d. The node 304d may include features 316d. Edge 306da may include features 332-3. The message 334da may be based on the features 316d and the features 332-3.

The node 304a may receive a message 334ea from node 304e. The node 304e may include features 316e. Edge 306ea may include features 332-4. The message 334ea may be based on the features 316e and the features 332-4.

Assume the node 304a receives the messages 334ba, 334ca, 334da, 334ea within the GNN layer 320b shown in FIG. 3A. The node 304a may apply a weight to each of the messages 334ba, 334ca, 334da, 334ea. The node 304a may apply a weight to each of the messages 334ba, 334ca, 334da, 334ea based on the weights 322b. The weights 322b may include a weight for each of the messages 334ba, 334ca, 334da, 334ea. For example, the weights 322b may include a first weight for the message 334ba, a second weight for the message 334ca, a third weight for the message 334da, and a fourth weight for the message 334ea.

The attention layer 318b may determine the weights 322b. The attention layer 318b may determine the first weight for the message 334ba based on the features 316b and the features 316a. The attention layer 318b may determine the second weight for the message 334ca based on the features 316c and the features 316a. The attention layer 318b may determine the third weight for the message 334da based on the features 316d and the features 316a. The attention layer 318b may determine the fourth weight for the message 334ea based on the features 316e and the features 316a. The first weight, the second weight, the third weight, and the fourth weight may be further based on a weighting coefficient and a bias coefficient. The attention layer 318b may learn the weighting coefficient and the bias coefficient.

Continuing with this example, the GNN layer 320b may determine embedded features for the node 304a based on the messages 334ba, 334ca, 334da, 334ea, the first weight, the second weight, the third weight, the fourth weight, and the features 316a. For example, the message 334ba may be a concatenation of the features 332-1 and the features 316b. The message 334ca may be a concatenation of the features 332-2 and the features 316c. The message 334da may be a concatenation of the features 332-3 and the features 316d. The message 334ea may be a concatenation of the features 332-4 and the features 316e. The GNN layer 320b may apply the first weight to the message 334ba to generate a weighted first message. The GNN layer 320b may apply the second weight to the message 334ca to generate a weighted second message. The GNN layer 320b may apply the third weight to the message 334da to generate a weighted third message. The GNN layer 320b may apply the fourth weight to the message 334ea to generate a weighted fourth message. The GNN layer 320b may sum the weighted first message, the weighted second message, the weighted third message, and the weighted fourth message to generate a message sum. The GNN layer 320b may concatenate the message sum and the features 316a to generate intermediate features. The GNN layer 320b may determine the hidden state for the node 304a based on the intermediate features. The GNN layer 320b may learn to determine the hidden state for the node 304a based on the intermediate features in order to achieve a highest accuracy on one or more downstream tasks. Utilizing the first weight, the second weight, the third weight, and the fourth weight may increase an accuracy of the GNN layer 320b (and an embedding model that includes the GNN layer 320b) for use in connection with one or more downstream tasks. These weights may also make the node embedding model 310 more transparent and explainable because the weights may make it possible to see which part of a molecule structure played a more important role during the inference.

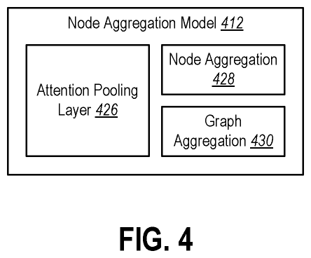

FIG. 4 illustrates a node aggregation model 412. The node aggregation model 412 may include node aggregation 428, graph aggregation 430, and an attention pooling layer 426.

The node aggregation 428 may aggregate embedded features of each node in a graph to generate aggregated node features for each node in the graph. The aggregated node features for each node in the graph may represent aggregated atom features when the graph represents a molecule. Consider the node embedding model 310. The node aggregation 428 may, for each node in the graph 302, aggregate embedded features for the node contained in the hidden states 324a-d to generate aggregated node features for the graph 302. The node aggregation 428 may apply any of a variety of aggregation policies possible for set-to-one mapping in order to determine the aggregated node features.

Consider a first node in the graph has first embedded features in the hidden state 324a, second embedded features in the hidden state 324b, third embedded features in the hidden state 324c, and fourth embedded features in the hidden state 324d. One aggregation policy may involve the node aggregation 428 concatenating the first embedded features, the second embedded features, the third embedded features, and the fourth embedded features to determine aggregated node features (which may also be referred to as final node features) for the node. As another example, the node aggregation 428 may select embedded features contained in one of the hidden states 324a-d (such as the fourth embedded features for the node in the hidden state 324d) as the final node features for the node. As another example, the node aggregation 428 may calculate a mean or a sum of the first embedded features, the second embedded features, the third embedded features, and the fourth embedded features.

As another example, the node aggregation 428 may determine a max of each axis in the first embedded features, the second embedded features, the third embedded features, and the fourth embedded features. Assume that the first embedded features, the second embedded features, the third embedded features, and the fourth embedded features are each vectors having n dimensions. For each dimension in the first embedded features, the second embedded features, the third embedded features, and the fourth embedded features, the node aggregation 428 may choose a maximum value among the first embedded features, the second embedded features, the third embedded features, and the fourth embedded features. The maximum value for each dimension is used to form the aggregated node features of the node.

The graph aggregation 430 may aggregate the aggregated node features determined by the node aggregation 428 to determine graph features for a graph. The graph features may be molecule features when the graph represents a molecule. The graph features may define a location of the graph in an embedding space. The graph aggregation 430 may apply any of a variety of aggregation policies to determine the graph features. For example, the graph aggregation 430 may apply any of the policies described above with respect to aggregating embedded features for a node.

The graph aggregation 430 may utilize an attention pooling layer 426 to determine the graph features. The attention pooling layer 426 may learn how to weight aggregated node features of nodes in a graph such that the graph aggregation 430 determines graph features that allow an embedding model to achieve a highest accuracy in downstream tasks. For example, consider a graph that includes a first node and a second node. Assume the first node has first aggregated node features and the second node has second aggregated node features. The attention pooling layer 426 may determine a first weight to apply to the first aggregated node features and a second weight to apply to the second aggregated node features. The first weight may be different from the second weight.

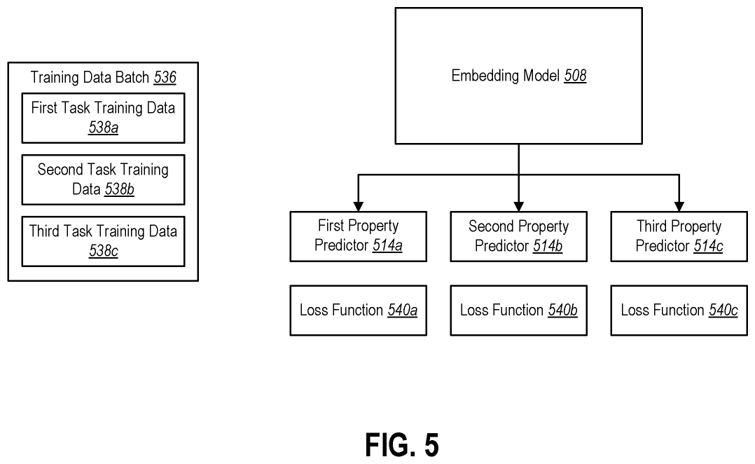

FIG. 5 illustrates an embedding model 508 that is trained using multi-task training. The embedding model 508 may be the embedding model 108. The embedding model 508 may include the node embedding model 310 and the node aggregation model 412.

The embedding model 508 may be trained using a training data batch 536. The training data batch 536 may include first task training data 538a, second task training data 538b, and third task training data 538c. The first task training data 538a, the second task training data 538b, and the third task training data 538c may include labeled training examples. In FIG. 5, the training data batch 536 contains training examples for three different tasks. But in other designs, a training data batch may include training data associated with more than three tasks.

The embedding model 508 may receive an input graph. The input graph may represent a molecule. The input graph may be associated with a training example contained in the training data batch 536. The embedding model 508 may output molecule features based on the input graph. The embedding model 508 may output the molecule features to a first property predictor 514a, a second property predictor 514b, and a third property predictor 514c. The first property predictor 514a may perform a first task with respect to the molecule features generated by the embedding model 508. The second property predictor 514b may perform a second task with respect to the molecule features generated by the embedding model 508. The third property predictor 514c may perform a third task with respect to the molecule features generated by the embedding model 508. The first task may be different from the second task and the third task. The second task may be different from the third task. For example, the first task may be predicting whether the molecule can penetrate into a brain barrier, the second task may be predicting whether the molecule is toxic, and the third task may be predicting octanol/water distribution coefficient (log D) of the molecule. The first task training data 538a may be associated with the first task. The second task training data 538b may be associated with the second task. The third task training data 538c may be associated with the third task.

The first property predictor 514a may have an associated loss function 540a. The second property predictor 514b may have an associated loss function 540b. The third property predictor 514c may have an associated loss function 540c. The embedding model 508 may use back propagation to learn from a loss determined by the loss function associated with a training example inputted into the embedding model 508. For example, if a training example came from the second task training data 538b, the embedding model 508 may use back propagation for loss determined by the loss function 540b.

The embedding model 508 may change based on the performance of its predictions and back propagation from the loss functions 540a-c. Each attention layer in the embedding model 508 may learn, from multi-task training using the training data batch 536, to determine weights to apply to messages that achieve a highest accuracy on the first task, the second task, and the third task. Each GNN layer in the embedding model 508 may learn, from multi-task training using the training data batch 536, to generate embedding features for each atom in a molecule graph that achieve a highest accuracy on the first task, the second task, and the third task.

By training the embedding model 508 on different tasks, the embedding model 508 may learn to generate an embedding space that is more generic (i.e., the embedding space will not learn to include required information for only a specific task) and that can be used in connection with performing a variety of downstream tasks. In other words, by training the embedding model 508 on different tasks, the embedding model 508 may learn to generate an embedding space that is richer in terms of an amount of information embedded into the embedding space.

Once the embedding model 508 is trained using multi-task training, the embedding model 508 may be re-trained on a specific downstream task. Training the embedding model 508 using multi-task training before doing task-specific training may be useful when a limited amount of labeled data exists for a specific task. The multi-task training in that situation may be considered as pretraining. Pretraining the embedding model 508 may allow the embedding model 508 to learn an embedding space that is sufficiently generic such that a small set of training data is sufficient to train the embedding model 508 for use in connection with a specific task.

Multi-task training may be useful to learn a mapping function (embedding) from a molecule space to a feature space when an unsupervised training approach similar to word-to-vector models in natural language processing is not available. In the word-to-vector models in natural language processing, a vector for a word may be learned based on how often the word appears close to other words in a document. It may be that a similar training task in the molecule space is not available or known.

Once the embedding model 508 is trained using multi-task training, the embedding model 508 may be used to map several molecules to an embedding space. It may be that one of the molecules mapped to the embedding space has certain known properties. Consider the following example. Assume that molecule A is known to have antibacterial properties. It may be that molecules close to molecule A in an embedding space may share similar antibacterial properties. Thus, the embedding model 508 may be used to screen possible molecules for testing and identify those molecules that have a highest likelihood of having properties similar to molecule A. Lab testing may focus on the molecules close to molecule A in the embedding space to determine whether the molecules close to molecule A have antibacterial properties. The embedding model 508 may reduce the expense and time associated with finding molecules that have properties similar to molecule A.

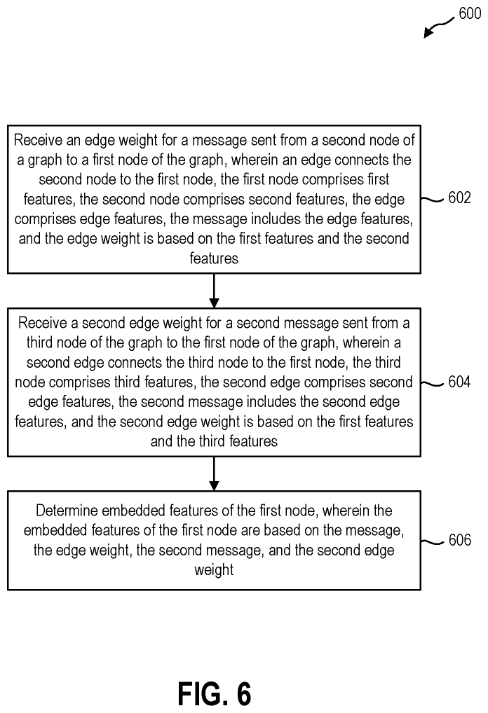

FIG. 6 illustrates an example method 600.

The method 600 may include receiving 602 an edge weight for a message sent from a second node of a graph to a first node of the graph, wherein an edge connects the second node to the first node, the first node comprises first features, the second node comprises second features, the edge comprises edge features, the message includes the edge features, and the edge weight is based on the first features and the second features. The edge weight may be further based on a learned weighting coefficient. The graph may represent a molecule. The graph may be based on a SMILES of the molecule. A graph neural network may receive the edge weight. The graph neural network may be a graph isomorphism network.

The method 600 may include receiving 604 a second edge weight for a second message sent from a third node of the graph to the first node of the graph, wherein a second edge connects the third node to the first node, the third node comprises third features, the second edge comprises second edge features, the second message includes the second edge features, and the second edge weight is based on the first features and the third features. The graph neural network may receive the second edge weight. The second edge weight may be further based on the learned weighting coefficient.

The method 600 may include determining 606 embedded features of the first node, wherein the embedded features of the first node are based on the message, the edge weight, the second message, and the second edge weight. The graph neural network may determine the embedded features of the first node.

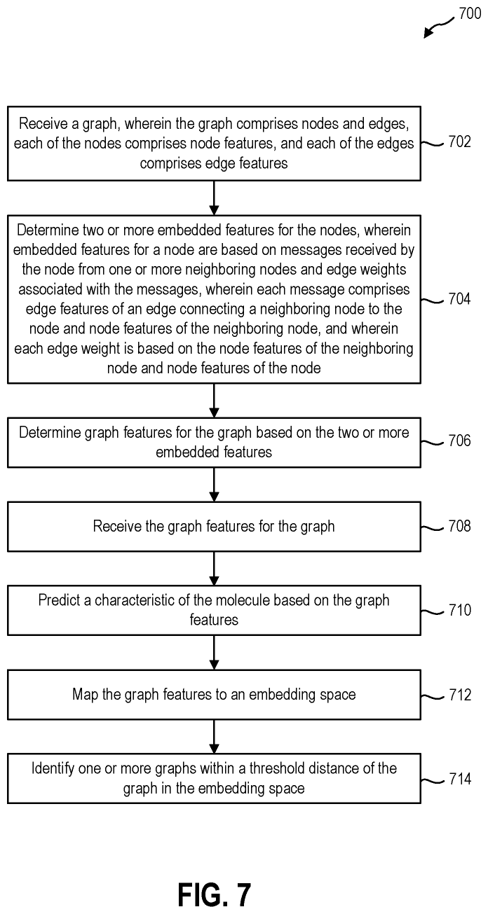

FIG. 7 illustrates an example method 700.

The method 700 may include receiving 702 a graph, wherein the graph comprises nodes and edges, each of the nodes comprises node features, and each of the edges comprises edge features. The graph may represent a molecule. The graph may be based on a simplified molecular-input line-entry system (SMILES) of the molecule.

The method 700 may include determining 704 two or more embedded features for the nodes, wherein embedded features for a node are based on messages received by the node from one or more neighboring nodes and edge weights associated with the messages, wherein each message comprises edge features of an edge connecting a neighboring node to the node and node features of the neighboring node, and wherein each edge weight is based on the node features of the neighboring node and node features of the node. Two or more graph neural network layers may determine the two or more embedded features for the nodes.

The method 700 may include determining 706 graph features for the graph based on the two or more embedded features.

The method 700 may include receiving 708 the graph features for the graph. A property predictor may receive the graph features of the graph.

The method 700 may include predicting 710 a characteristic of the molecule based on the graph features. The property predictor may predict the characteristic of the molecule.

The method may include mapping 712 the graph features to an embedding space.

The method may include identifying 714 one or more graphs within a threshold distance of the graph in the embedding space.

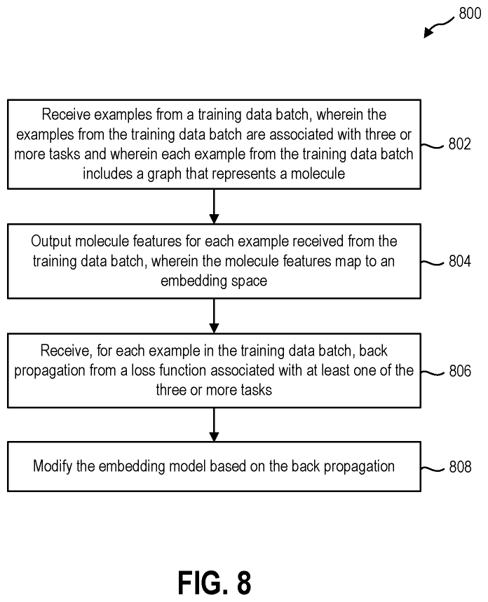

FIG. 8 illustrates an example method 800.

The method 800 may include receiving 802 examples from a training data batch, wherein the examples from the training data batch are associated with three or more tasks and wherein each example from the training data batch includes a graph that represents a molecule. An embedding model may receive the examples. The embedding model may include one or more graph neural network layers and one or more attention layers. The graph may include nodes and edges. The one or more graph neural network layers may use a message-passing framework. The one or more attention layers may determine edge weights to be applied to messages received by a receiving node in the graph from one or more sending nodes in the graph based on how the message-passing framework propagates information in the graph. The edge weights may be based on features of the receiving node and the one or more sending nodes and on a weighting coefficient.

The method 800 may include outputting 804 molecule features for each example received from the training data batch, wherein the molecule features map to an embedding space. The embedding model may output the molecule features. The molecule features may be based in part on the edge weights and the messages.

The method 800 may include receiving 806 for each example in the training data batch, back propagation from a loss function associated with at least one of the three or more tasks. Learnable weights of the embedding model may be changed based on the back propagation.

The method 800 may include modifying 808 the embedding model based on the back propagation. The one or more attention layers may modify the weighting coefficient based on the back propagation.

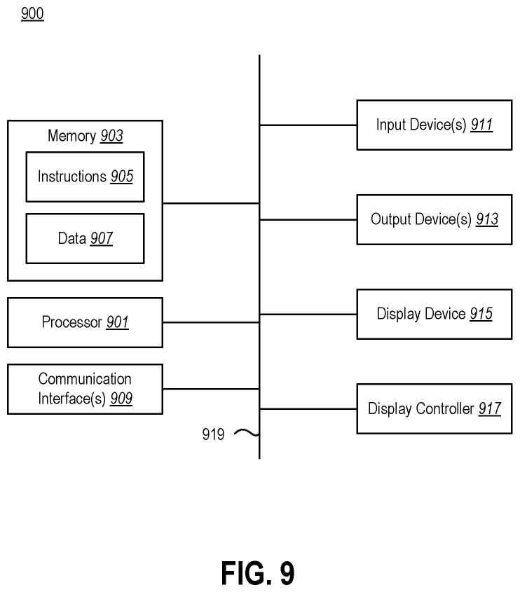

Reference is now made to FIG. 9. One or more computing devices 900 can be used to implement at least some aspects of the techniques disclosed herein. FIG. 9 illustrates certain components that can be included within a computing device 900.

The computing device 900 includes a processor 901 and memory 903 in electronic communication with the processor 901. Instructions 905 and data 907 can be stored in the memory 903. The instructions 905 can be executable by the processor 901 to implement some or all of the methods, steps, operations, actions, or other functionality that is disclosed herein. Executing the instructions 905 can involve the use of the data 907 that is stored in the memory 903. Unless otherwise specified, any of the various examples of modules and components described herein can be implemented, partially or wholly, as instructions 905 stored in memory 903 and executed by the processor 901. Any of the various examples of data described herein can be among the data 907 that is stored in memory 903 and used during execution of the instructions 905 by the processor 901.

Although just a single processor 901 is shown in the computing device 900 of FIG. 9, in an alternative configuration, a combination of processors (e.g., an Advanced RISC (Reduced Instruction Set Computer) Machine (ARM) and a digital signal processor (DSP)) could be used.

The computing device 900 can also include one or more communication interfaces 909 for communicating with other electronic devices. The communication interface(s) 909 can be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The computing device 900 can also include one or more input devices 911 and one or more output devices 913. Some examples of input devices 911 include a keyboard, mouse, microphone, remote control device, button, joystick, trackball, touchpad, and lightpen. One specific type of output device 913 that is typically included in a computing device 900 is a display device 915. Display devices 915 used with embodiments disclosed herein can utilize any suitable image projection technology, such as liquid crystal display (LCD), light-emitting diode (LED), gas plasma, electroluminescence, wearable display, or the like. A display controller 917 can also be provided, for converting data 907 stored in the memory 903 into text, graphics, and/or moving images (as appropriate) shown on the display device 915. The computing device 900 can also include other types of output devices 913, such as a speaker, a printer, etc.

The various components of the computing device 900 can be coupled together by one or more buses, which can include a power bus, a control signal bus, a status signal bus, a data bus, etc. For the sake of clarity, the various buses are illustrated in FIG. 9 as a bus system 919.

The techniques disclosed herein can be implemented in hardware, software, firmware, or any combination thereof, unless specifically described as being implemented in a specific manner. Any features described as modules, components, or the like can also be implemented together in an integrated logic device or separately as discrete but interoperable logic devices. If implemented in software, the techniques can be realized at least in part by a non-transitory computer-readable medium having computer-executable instructions stored thereon that, when executed by at least one processor, perform some or all of the steps, operations, actions, or other functionality disclosed herein. The instructions can be organized into routines, programs, objects, components, data structures, etc., which can perform particular tasks and/or implement particular data types, and which can be combined or distributed as desired in various embodiments.

The term “processor” can refer to a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, or the like. A processor can be a central processing unit (CPU). In some embodiments, a combination of processors (e.g., an ARM and DSP) could be used to implement some or all of the techniques disclosed herein.

The term “memory” can refer to any electronic component capable of storing electronic information. For example, memory may be embodied as random access memory (RAM), read-only memory (ROM), magnetic disk storage media, optical storage media, flash memory devices in RAM, various types of storage class memory, on-board memory included with a processor, erasable programmable read-only memory (EPROM), electrically erasable programmable read-only memory (EEPROM) memory, registers, and so forth, including combinations thereof.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

The term “determining” (and grammatical variants thereof) can encompass a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there can be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method comprising:
receiving, at a graph neural network, an edge weight for a message sent from a second node of a graph to a first node of the graph, wherein an edge connects the second node to the first node, the first node comprises first features, the second node comprises second features, the edge comprises edge features, the message includes the edge features, and the edge weight is based on the first features and the second features; and
determining, at the graph neural network, embedded features of the first node, wherein the embedded features of the first node are based on the message and the edge weight.

2. The method of claim 1, wherein the graph represents a molecule.

3. The method of claim 2, wherein the graph is based on a simplified molecular-input line-entry system (SMILES) of the molecule.

4. The method of claim 1, wherein the graph neural network is a graph isomorphism network (GIN).

5. The method of claim 1 further comprising:
receiving, at the graph neural network, a second edge weight for a second message sent from a third node of the graph to the first node of the graph, wherein a second edge connects the third node to the first node, the third node comprises third features, the second edge comprises second edge features, the second message includes the second edge features, and the second edge weight is based on the first features and the third features.

6. The method of claim 5, wherein determining, at the graph neural network, the embedded features of the first node is further based on the second message and the second edge weight.

7. The method of claim 1, wherein the message includes the second features.

8. The method of claim 1, wherein the edge weight is further based on a learned weighting coefficient.

9. A method comprising:
receiving a graph, wherein the graph comprises nodes and edges, each of the nodes comprises node features, and each of the edges comprises edge features;
determining, using two or more graph neural network layers, two or more embedded features for the nodes, wherein embedded features for a node are based on messages received by the node from one or more neighboring nodes and edge weights associated with the messages, wherein each message comprises edge features of an edge connecting a neighboring node to the node and node features of the neighboring node, and wherein each edge weight is based on the node features of the neighboring node and node features of the node; and
determining graph features for the graph based on the two or more embedded features.

10. The method of claim 9, wherein the graph represents a molecule.

11. The method of claim 10, wherein the graph is based on a simplified molecular-input line-entry system (SMILES) of the molecule.

12. The method of claim 10 further comprising:
receiving, at a property predictor, the graph features for the graph; and
predicting, using the property predictor, a characteristic of the molecule based on the graph features.

13. The method of claim 10 further comprising:
mapping the graph features to an embedding space; and
identifying one or more graphs within a threshold distance of the graph in the embedding space.

14. The method of claim 10, wherein the two or more graph neural network layers include a graph isomorphism network (GIN) layer.

15. The method of claim 10, wherein the two or more graph neural network layers receive the edge weights from two or more attention layers and the edge weights may be used to identify a portion of the molecule that played a more important role during inference than another portion of the molecule.

16. A method comprising:
receiving, at an embedding model, examples from a training data batch, wherein the examples from the training data batch are associated with three or more tasks and wherein each example from the training data batch includes a graph that represents a molecule;
outputting, from the embedding model, molecule features for each example received from the training data batch, wherein the molecule features map to an embedding space;
receiving, at the embedding model, for each example in the training data batch, back propagation from a loss function associated with at least one of the three or more tasks; and
modifying learnable weights of the embedding model based on the back propagation.

17. The method of claim 16, wherein the embedding model includes one or more graph neural network layers and one or more attention layers.

18. The method of claim 17, wherein the graph includes nodes and edges, wherein the one or more graph neural network layers use a message-passing framework, wherein the one or more attention layers determine edge weights to be applied to messages received by a receiving node in the graph from one or more sending nodes in the graph, and wherein the molecule features are based in part on the edge weights and the messages.

19. The method of claim 18, wherein the edge weights are based on features of the receiving node and the one or more sending nodes.

20. The method of claim 19, wherein the edge weights are further based on a weighting coefficient and the one or more attention layers modify the weighting coefficient based on the back propagation.
